(19) United States
(12) Patent Application Publication
(10) Pub. No.: US 2006/0017970 A1
(43) Pub. Date: Jan. 26, 2006

(54) Image forming system, apparatus and method

(75) Inventors: Hyun-jung Park, Suwon-si (KR); Sobko Sergey, Suwon-si (KR); Han-sung Kim, Seoul (KR); Dong-hyeop Han, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/186,821

(22) Filed: Jul. 22, 2005

(30) Foreign Application Priority Data
Jul. 24, 2004 (KR) 2004-0058079
Sep. 14, 2004 (KR) 2004-0073411
Dec. 10, 2004 (KR) 2004-0103925

(51) Int. Cl. G06F 3/12; G06F 15/00

(52) U.S. Cl. 358/1.15

(57) ABSTRACT

Disclosed is an image forming system comprising a first device and a second device connected to a network, and having an output permission and result notification function for image data stored in the first device. The system comprises a control unit for transferring a request for approval of the first device to the second device and transferring to the first device a response of the second device to the request for approval, and transforming the image data into a printable format and outputting the transformed image data. The request of approval requests an approval of the second device for printing of the image data. The image data is transferred to the control unit from the first device in response to an output permission in the response of the second device. The system comprises a printing unit for printing on a print paper an image corresponding to the transformed image data.

This application claims the benefit under 35 U.S.C. § 119(a) of Korean Patent Application No. 2004-58079, filed on Jul. 24, 2004, Korean Patent Application No. 2004-73411, filed on Sep. 14, 2004, and Korean Patent Application No. 2004-103925, filed on Dec. 10, 2004, the entire contents of which are incorporated herein by reference.

### BACKGROUND OF THE INVENTION

1. Field of the Invention

The present invention relates to an image forming system, apparatus and method. More specifically, the invention relates to an image forming system, apparatus and method, which provide a security authentication function or a management for an image data stored in the image forming apparatus that is connected to a host device through a network.

2. Description of the Related Art

Due to advancements in network and communication technologies, a system, where a document can be created on a computer and the document can be printed using an output device such as a printer or the like, has come to be formed in the network environment.

In a wired or wireless network printer system having at least one computer and at least one printer connected thereto, a user can print a document created on the at least one computer through the printer on the network.

Notwithstanding this advancement in the network printer system, when the owner of a document to be printed needs to output the document to other users on the network, not for his or her own purpose, he or she must print the document in the conventional manner, and then transfer the printed document to the other user or ask the other users to take the printed document from the printer.

In these circumstances, the document owner must call the other user to take the output document, or visit the other user in person. Even if the printed document is transferred or delivered, unintended people may take the document, thus causing a security problem. In addition, the other user may not need the printed document, thus wasting resources.

On the other hand, a security and management function is needed, with respect to an image data stored in the hard disk of an image forming apparatus such as a printer connected to a network. Conventionally, this security and management function has been managed, on the job base and on the user base.

However, in case of the conventional job base management, a user's ID and password must be generated and stored respectively. In addition, if it is managed on the user base, the sharing of stored image data is not practically achieved. Furthermore, in the case where a user 1 stores an image data in a printer or the like and another user 2 tries to print the image data stored by the user 1, the user 2 can not print the image data, based on not knowing the password, and thus must ask for the password from the user 1.

On the other hand, as the size of image data being received has increased, the image forming apparatus has been provided with a separate image data storage means in order to support various processing of the image data. By using this separate image data storage means, the user can send the image data with a desired command attached thereto while commanding the printing therefor. Accordingly, the image forming apparatus stores the received image data in a storage means and then can print or administrate it in various modes.

For example, in a storage mode, the image forming apparatus receives an image data and stores it in a storage means, and later can print and delete or re-store the image data. In a safe mode, the received image data is not immediately printed, i.e., printed after a password is input. In addition, in a delay mode, the received image data is printed at a certain pre-established time.

However, although a transferred image data is simply stored in a storage means and the stored image data is processed in a print mode, the number of stored jobs are increased and these jobs are not appropriately managed, thereby increasing the load of the image forming apparatus. For this management, a more sophisticated management function must be provided.

Furthermore, in case of a safe mode, there is a possibility that the user forgets to input a password. In this case, data printing is not executed, but the user may delete the concerned document or image data from his or her computer, believing that the document data have been printed out.

In case of a delay mode, even if a document is printed at a pre-established time, the user may not be aware that the document has been printed, or a person without authority may take the printed document.

### SUMMARY OF THE INVENTION

The present invention has been made in order to solve the above drawbacks and other problems in the art. An object of the invention is to provide an image forming system and method having an output permission and result notification function, in which information on a document is provided to a document receiver connected to a network and an output permission is obtained therefrom, and then the concerned document is output, thereby avoiding waste of resources and maintaining the security of document.

Another object of the invention is to provide an image forming apparatus and method having a management function of a stored image data, in which, when a state change information comprising a printing and deleting of an image data stored in the storage means of the image forming apparatus has occurred, the state change information is indicated to a user, thereby managing appropriately the stored image data.

A further object of the invention is to provide an image forming system and method having a security authentication function, in which, when an image data stored in the recording medium of an image forming apparatus is needed to be printed, a printing approval can be performed by a creator onto a network, thereby enabling the security authentication and sharing of the image data.

According to one aspect of the invention for achieving the objects, there is provided an image forming system comprising a first device and a second device connected to a network, and having an output permission and result notification function for image data stored in the first device. The system of the invention comprises a control unit for transferring a request for approval of the first device to the second device for printing of the image data, transferring to the first device a response of the second device based on the request for approval, and transforming the image data into a printable format and outputting the transformed image data, the image data being transferred to the control unit from the first device in response to an output permission in response to the second device; and a printing unit for printing on a print paper an image corresponding to the transformed image data output from the control unit.

Here, if the printing unit prints an image corresponding to the image data on a print paper, preferably, the control unit transfers the output result to the second device.

In addition, preferably, the request for approval comprises the address of the second device and information on a document to be printed.

According to another aspect of the invention for achieving the above objects, there is provided a method of performing an output permission and result notification in an image forming system having a first device, a second device, and an image forming apparatus, which are connected onto a network. The method of the invention comprises the steps of transferring a request for approval to the image forming apparatus by means of the first device, wherein the request of approval comprises requesting an approval from the second device for printing of an image data stored in the first device; transferring the request for approval to the second device by means of the image forming apparatus; making a response to the request for approval by means of the second device, the response comprising an output permission; transferring the response to the first device by means of the image forming apparatus; transferring the image data to the image forming apparatus by means of the first device, in response to the output permission in the response; printing an image corresponding to the image data by means of the image forming apparatus; and transferring the printing result to the second device by means of the image forming apparatus.

According to another aspect of the invention for achieving the objects, there is provided a method of performing a security authentication in an image forming system having a first device, a second device, and an image forming apparatus, which are connected onto a network. The method of the invention comprises the steps of requesting a printing of an image data stored in the image forming apparatus by means of the first device; requesting an approval for printing to the second device by means of the image forming apparatus; approving the request for printing, in response to the request for approval of printing by means of the second device; and printing an image corresponding to the image data on a print paper by means of the image forming apparatus, in response to the approval.

Here, preferably, the step of requesting the printing comprises the steps of requesting a list of image data stored in the image forming apparatus by means of the first device; transferring the list to the first device by means of the image forming apparatus; and selecting the image data and requesting a printing to the image forming apparatus.

In addition, at least one of the first device and the second device is preferred to be provided in the image forming apparatus.

Preferably, the step of requesting the printing comprises a step of the first device being input an identification of a requester, who requests a printing, and transferring the identification to the image forming apparatus, along with the image data.

Preferably, the step of requesting the approval comprises a step of transferring to the second device the image data information and a requester information pre-stored in the image forming apparatus, both of which correspond to the requester identification.

Preferably, the step of requesting the approval comprises a step of transferring to the first device information, corresponding to a case where the second device cannot perform communication on the network.

The second device is preferred to be a device owned by an approval authority, who has an authority of approving printing of the requested image data.

In addition, the step of approving the request for printing may comprise the steps of inputting an authorization code into the second device by means of the approval authority; and transferring the authorization code to the image forming apparatus.

The step of printing the image comprises the steps of comparing the authorization code with an authorization code pre-established for the image data, by means of the image forming apparatus; and transforming the image data into a printable format when the authorization codes are matched as the result of comparison.

As a result of the comparison, if the authorization codes are not matched, preferably, a corresponding information is transferred to the second device.

Here, preferably, the step of printing the image comprises a step of transferring to the first device information, which corresponds to a case where the image forming apparatus does not receive the request for approval from the second device after the established time.

According to another aspect of the invention for achieving the objects, there is provided an image forming system having a security authentication function for an image data stored in an image forming apparatus and having one or more devices connected to a network. The image forming system comprises a first device for performing a printing request of a requester with respect to the image data; a second device for performing a printing approval of an approval authority with respect to the image data; a recording medium for recording the image data; and a control unit for receiving the printing request for the image data from the first device and transferring the printing request to the second device, and receiving the printing approval from the second device and transforming the image data in order to print an image corresponding thereto on a print paper.

The image forming system of the invention may further comprise a printing unit for printing an image corresponding to the transformed image data, which is received from the control unit.

Here, preferably, the first device requests, for the printing request, to the control unit a list of image data stored in the recording medium, and the control unit transfers the list to the first device in response to the request for the list from the request unit.

In addition, with respect to the printing request, preferably, the first device receives as an input an identification of the requester and transfers the identification to the control unit.

Here, preferably, the control unit transfers to the second device the image data information and a requester information pre-stored in the image forming apparatus, both of which correspond to the requester identification.

In addition, with respect to transferring of the printing request, preferably, the control unit transfers to the first device information, which corresponds to a case where the second device cannot perform communication on a network.

Preferably, the second device receives as an input an authorization code from the approval authority and transfers the authorization code to the image forming apparatus.

Here, preferably, the control unit compares the authorization code with a pre-established authorization code for the image data, and, if the authorization codes are matched, transforms the image data into a printable format.

In addition, as a result of the comparison, if the authorization codes are not matched, the control unit is preferred to transfer a corresponding information to the second device.

Here, preferably, at least one of the first device and the second device is provided in the image forming apparatus.

According to another aspect of the invention for achieving the objects, there is provided a method of managing a stored image data in an image forming apparatus. The method of the invention comprises the steps of receiving a printing job stored in any one option from among a plurality of storage options; storing the received printing job; and transmitting a state change information occurring in the stored printing job to a user through a network.

Here, preferably, the step of transmitting comprises a step of transmitting the state change information using any one of a user's email address, a character message and a voice message.

In addition, preferably, the step of transmitting comprises a step of transmitting the state change information to any one of a user's system and a user's portable terminal through the network.

When the storage options correspond to a storage mode which stores the printing job for a pre-established period of time, the state change information comprises information on any one of cases where the printing job is printed, the printing job is deleted, and the established time is reached.

Here, in case where the storage mode printing job reaches a pre-established time and thus the state change information is transferred to a user, any one command of deleting the storage mode printing job and storing the storage mode printing job by means of a new establishment of time may be received from the user.

When the storage options correspond to a safe mode which requires an input of a password for the execution of printing job, the state change information comprises information on any one of cases where the printing job is printed and the established time is reached.

Furthermore, the state change information may comprise information on a state where the printing job reaches a pre-established time and is thus printed, and the information corresponds to a delay mode where the printing job is printed after a pre-established period of time.

According to another aspect of the invention for achieving the objects, there is provided an image forming apparatus having a management function for a stored image data and connected to a first device through a network. The image forming apparatus comprises a recording medium for storing a printing job established in any one option among a plurality of storage options; a control unit for storing into the recording medium the printing job received from the first device and transmitting to a user a state change information occurring in the stored printing job; and a printing unit for printing an image corresponding to an image data transferred from the control unit on a print paper.

Here, preferably, the control unit transmits the state change information using any one of a user's email address, a character message and a voice message.

In addition, preferably, the control unit transfers the state change information to the first device through the network.

When the storage options correspond to a storage mode which stores the printing job for a pre-established period of time, the state change information comprises information on any one of cases where the printing job is printed, the printing job is deleted, and the established time is reached.

Here, preferably, in case where the storage mode printing job reaches a pre-established time and thus the state change information is transferred to a user, any one command of deleting the storage mode printing job and storing the storage mode printing job by means of a new establishment of time is received from the user.

In addition, when the storage options correspond to a safe mode which requires an input of a password for the execution of printing job, the state change information comprises information on any one of cases where the printing job is printed and the established time is reached.

Furthermore, the state change information may comprise information on a state where the printing job reaches a pre-established time and is thus printed, and the information corresponds to a delay mode where the printing job is printed after a pre-established period of time.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram of an image forming system having an output approval and result notification function according to an embodiment of the invention;

FIG. 2 is a flow chart illustrating the output approval and result notification function in the image forming system of the invention;

FIG. 3 is a block diagram showing an image forming system having a security authentication function for image data according to an embodiment of the invention;

FIG. 4 is a block diagram showing an image forming system having a security authentication function for image data according to another embodiment of the invention;

FIG. 5 is a flow chart illustrating the operation of the image forming system having the security authentication function according to an embodiment of the invention;

FIG. 6 is a block diagram of an image forming apparatus having a management function for stored image data according to an embodiment of the invention;

FIG. 7 is a flow chart illustrating a method of processing a storage mode job in the image forming system of the invention;

FIG. 8 is a flow chart illustrating a method of processing a safe mode job in the image forming system of the present invention; and

FIG. 9 is a flow chart illustrating a method of processing a delay mode job in the image forming system of the present invention.

Throughout the drawings, the same or similar elements, features and structures are represented by the same reference numerals.

### DETAILED DESCRIPTION OF EXEMPLARY EMBODIMENTS

Certain embodiments of the present invention will be described in greater detail with reference to the accompanying drawings.

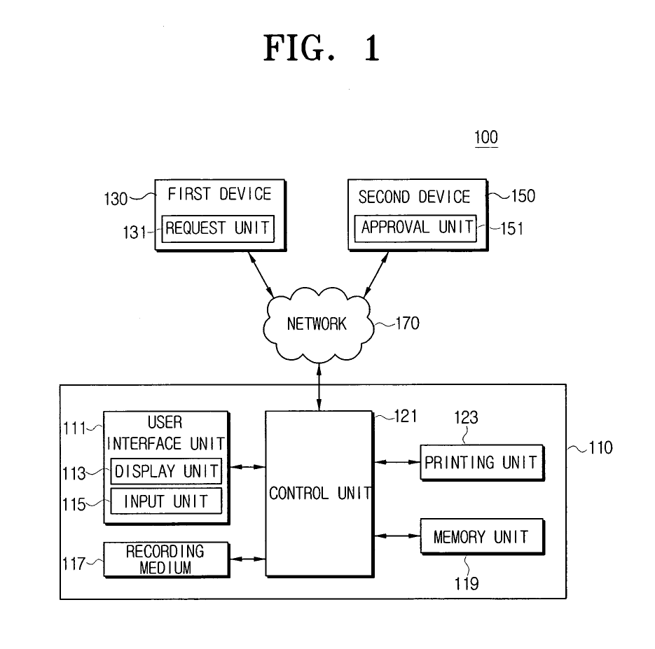

FIG. 1 is a block diagram of an image forming system having an output approval and result notification function according to an embodiment of the invention where the image forming system of the invention is generally denoted by reference numeral 100. Referring to FIG. 1, the image forming system 100 of the invention comprises a first device 130, a second device 150 and an image forming apparatus 110, which are interconnected through a network 170.

The network 170 comprises a wired and wireless network, through which a single image forming apparatus 110 can be shared by a plurality of devices.

The first device 130 and the second device 150 generate an image data to be printed through the image forming apparatus 110, and then send the image data to the image forming apparatus 110 through the network 170.

The first device 130 and the second device 150 can be connected to the network 170, and generate an image data to be printed through the image forming apparatus 110, such as documents, photographs or the like. The first and second devices 130 and 150 comprise a computer, a digital camera, a scanner, a notebook, a cellular phone, a personal digital assistant (PDA), and the like.

A user of the first device 130 can transmit a document retained in its own memory to a user of the second device 150 or other devices (not illustrated) on the network 170. For this purpose, the first device 130 has a function, which is configured such that the first device 130 sends the document to the user of the second device 150 or other device through the network 170, obtains a print permission, and then performs a printing job.

In this case, the image forming apparatus 110 serves as a host device, and the first device and second device 130 and 150 serve as a client device.

The first device 130 comprises a request unit 131.

The request unit 131 outputs through the image forming apparatus 110 the image data of a document, which is retained in the first device 130 and required to be sent to a user of the second device 150. This is hereinafter referred to as an “approved printing.”

First, if a command for the approved printing of a concerned document is received from the user of the first device 130, the request unit 131 sends a request for approval to the image forming apparatus 110, along with information on the concerned document and the address of the second device 150 for delivery.

Thereafter, if information on the output permission is received through the image forming apparatus 110, the request unit 131 transmits an image data of the document to the image forming apparatus where it is printed. If information on the output rejection is received from the image forming apparatus 110, the request unit 131 displays the fact on a display unit (not shown) for the user of the first device. In this case, the first device 130 does not send the image data of the concerned document to the image forming apparatus 110.

The second device 150 comprises an approval unit 151.

The approval unit 151 receives from the image forming apparatus 110 a request for approval for printing of a document stored in the first device 130 and displays this on a display unit (not shown) to thereby notify the user of the second device 150. Then, the approval unit 151 is to be input an “output permission” or an “output rejection” by the user of the second device 150.

If an output permission for the requested document is received from the user of the second device 150, the approval unit 151 sends to the image forming apparatus 110 a response comprising information on the output permission so as to print the document. If the requested document is not required to be printed and thus an output rejection is input by the user of the second device 150, the approval unit 151 sends to the image forming apparatus 110 a response comprising information on the output rejection so as not to print the relevant document.

If the approval unit 151 receives from the image forming apparatus 110 an output result that the approved document has been printed, it displays the fact on a display device (not illustrated) to thereby notify the user of the second device 150.

In another embodiment of the invention, each of the first device 130 and the second device 150 may comprise both the request unit 131 and the approval unit 151, such that the second device 150 can request an approved printing and the first device 130 can permit or reject the request from the second device 150.

The image forming apparatus 110 may comprise a computer printer, a replicator, a photoprinter, and the like, capable of being connected on the network 170. The image forming apparatus 110 performs a printing job in response to a printing command from a device on the network 170.

The image forming apparatus 110 comprises a user interface unit 111, a recording medium 117, a memory unit 119, a control unit 121, and the printing unit 123.

The user interface unit 111 comprises a display unit 113 and an input unit 115.

The display unit 113 denotes a device, in which information transmitted from the control unit 121 is displayed in the form of a character or figure so as to be recognizable to the user. The display unit 113 can employ a display device such as a liquid crystal display (LCD) capable of displaying a character or figure.

The input unit 115 is to be input a user's command, a system setting, or the like.

The recording medium 117 is a device where the image data transmitted through the first device 130, the second device 150 or the like is spooled and stored in a single job unit. The recording medium 117 may employ a memory element, a hard disk, a floppy disk, an external storage device, and the like. Preferably, a hard disk can be used as the recording medium 117.

The memory unit 119 denotes an active memory device, in which an image data to be printed is temporarily stored while being processed for a final printing.

The control unit 121 controls the entire image forming processing in the image forming apparatus 110, and at the same time serves as a host device in response to a request for approval.

If the control unit 121 receives from the first device 130 a request for approved printing along with the address of the second device 150 and information on a document to be printed, it analyzes the address of the second device 150 and sends information on the document to be printed to the second device 150.

If the control unit 121 receives a response comprising information on the output permission or the output rejection from the second device 150, it sends them to the first device 130.

If an image data for the approved document is received from the first device 130, the control unit 121 transforms the image data into a format processible in the printing unit 123 and transmits the transformed image data to the printing unit 123.

When the approved document is printed in the printing unit 123, the control unit 121 transfers the output result to the first device 130.

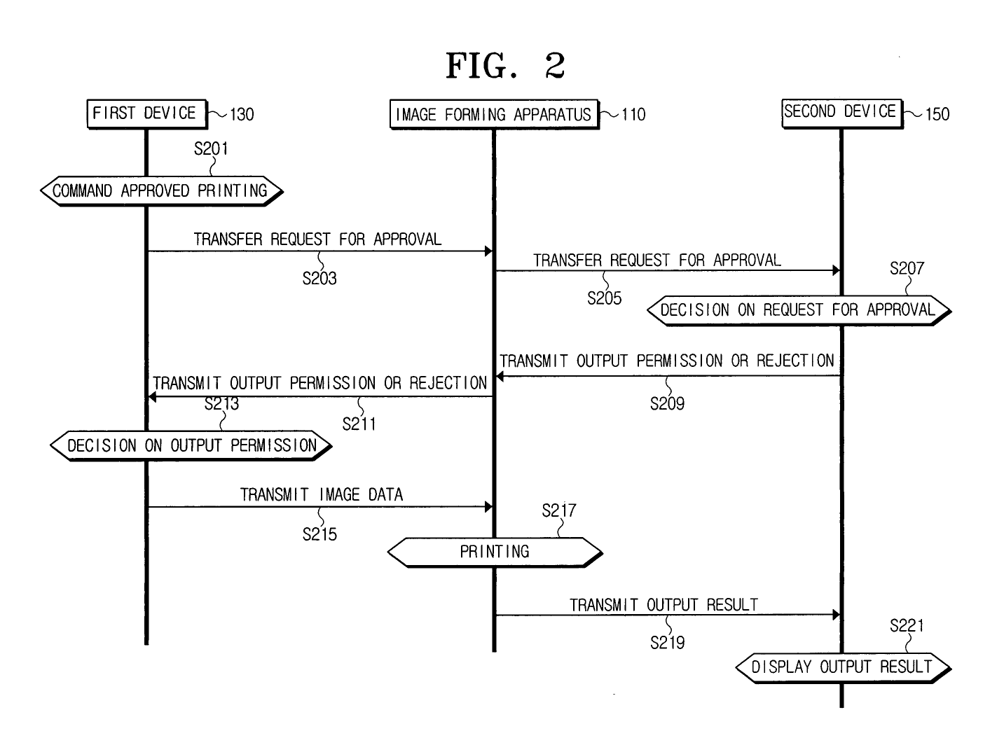

FIG. 2 is a flow chart illustrating the output approval and result notification function in the image forming system of the invention.

If the request unit 131 of the first device 130 receives from a user of the first device 130 a command of an approved printing to the second device 150 at step S201, the request unit 131 transfers the request for approval (comprising information on the relevant document and the address of the second device) to the control unit 121 of the image forming apparatus 110 at step S203.

The control unit 121 of the image forming apparatus 110 transfers the request for approval to the second device 150, which is included in the request for approval at step S205.

The request of approval is transferred in the approval unit 151 of the second device 150, which then displays the fact on a display device (not shown) to thereby notify the user of the second device 150 and receives as an input a command of output permission or rejection at step S207.

The approval unit 151 transfers to the image forming apparatus 110 a response comprising information on the output permission or rejection input by the user of the second device 150, along with the address of the first device 130 at step S209.

The image forming apparatus 110 transfers to the first device 130 a response comprising information on the transferred output permission and rejection at step S211.

The request unit 131 of the first device 130 makes a decision as to whether the response transferred from the image forming apparatus 110 comprises an output rejection. If it comprises information on the output rejection, the request unit 131 does not transfer the image data for the document to be printed to the image forming apparatus 110. Instead, the request unit 131 displays the output rejection information on a display unit (not shown) to thereby notify the user of the first device 130 at step S213.

If the response comprises an output permission, the request unit 131 transfers the image data for the document to be printed to the image forming apparatus 110 at step S215.

When the image data is transferred from the first device 130, the control unit 121 of the image forming apparatus 110 spools and stores image data, and then starts to print the relevant image data. The control unit 121 transforms the image data into a format processible in the printing unit 123 and then transfers the transformed data to the printing unit 123.

The printing unit 123 prints an image corresponding to the transferred image data on a print paper at step S217.

After the approved document is printed in the printing unit 123, the control unit 121 transmits information on the output result to the second device 150 at step S219.

If the information on the output result is transmitted from the image forming apparatus 110, the approval unit 151 of the second device 150 displays the relevant information to the user of the second device 150 at step S221.

The image forming system having an output permission and result notification function is operated in the above-described manner.

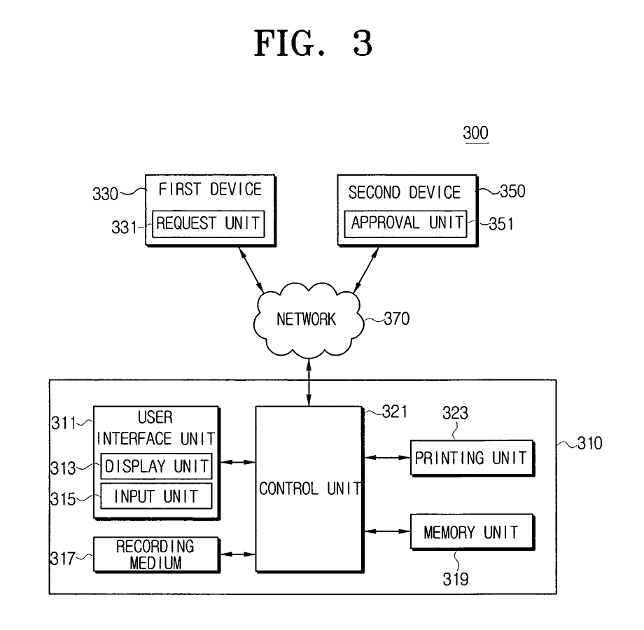

FIG. 3 is a block diagram showing an image forming system having a security authentication function for image data according to an embodiment of the invention, where the image forming system of the invention is generally denoted by reference numeral 300. Referring to FIG. 3, the image forming system 300 of the invention comprises a first device 330, a second device 350 and an image forming apparatus 310, which are interconnected through a network 370.

The network 370 comprises a wired and wireless network, through which a single image forming apparatus 310 can be shared by a plurality of devices.

The image forming apparatus 310 may comprise a computer printer, a replicator, a photoprinter, and the like, capable of being connected on the network 370. The image forming apparatus 310 performs a printing job in response to a printing command from a device on the network 370.

The image forming apparatus 310 comprises a user interface unit 311, a recording medium 317, a memory unit 319, a control unit 321, and a printing unit 323.

An image data shared through the image forming apparatus 310 is stored in the recording medium 317. In order for an image data creator to generate an image data and share the generated image data through the image forming apparatus 310, the image data is to be stored in the image forming apparatus 310, along with an authorization code attached to the image data. The image forming apparatus 310 allows information on the image data creator using the already-stored user information, the authorization code, and information on the concerned image data to be stored in the memory unit 319, and allows the image data to be stored in the recording medium 317.

The user interface unit 311 comprises a display unit 313 and an input unit 315.

The display unit 313 denotes a display device, in which information transmitted from the control unit 321 is displayed in the form of a character or figure so as to be recognizable to the user. The display unit 313 can employ a display device such as a LCD capable of displaying a character or figure.

The input unit 315 is to be input a user's command, system settings, or the like.

The recording medium 317 is a device where the image data transmitted through the first device 330, the second device 350 or the like is spooled and stored in a single job unit. The recording medium 317 may employ a memory element, a hard disk, a floppy disk, an external storage device, and the like. Preferably, a hard disk can be used as the recording medium 317.

The memory unit 319 denotes an active memory device, in which a list of image data stored in the recording medium 317 and the authorization code attached to each image data can be stored. In addition, a list of users on the network 370 and the identification of each user can be stored in the memory unit 319.

The control unit 321 controls the entire image forming processing performed in the image forming apparatus 310. In addition, if a request for printing an image data stored in the recording medium 317 is received, the control unit 321 notifies the relevant approval authority of the request and obtains an approval for the request of printing. That is, the control unit 321 controls a security management and a shared job. Thus, the control unit 321 does not allow printing an image data, without approval of the approval authority, even if it is shared, and controls the shared job to be preformed through the network 370.

In order to control the security management and the shared job, if a list of image data stored in the recording medium 317 is requested from the first device 330, the control unit 321 transfers the list of image data stored in the memory unit 319 to the first device 330, that accepts the authorization code thereof. In addition, it receives from the first device a request for printing comprising the requester identification and information on the selected image data.

If a request for printing is received, the control unit 321 reads out the requester information from the user information stored in the memory unit 319, using the requester identification. Then, the request for printing comprising information on the requester and the image data is transferred to the second device 350.

An authorization code is input from the second device 350 to the control unit 321, which then compares the input authorization code with that of the concerned image data stored in the memory unit 319 and determines whether they are in accordance with each other or match. If they are in accordance, the control unit 321 transforms the corresponding image data into a printable format processible in the printing unit 323 and then transfer the transformed data to the printing unit 323.

If the comparison result does not match, the control unit 321 transfers to the second device 350 the fact that the authorization codes does not conform to each other.

When the control unit 321 receives a request for printing from the first device 330 and the communication with the second device 350 is not properly performed, it transmits the information therefor to the first device 330.

The printing unit 323 analyzes the transformed image data transferred from the control unit 321 and prints the corresponding image on a print paper.

The first device 330 and the second device 350 are connected onto the network 370 to thereby be able to send an image data to the image forming apparatus 310 where it is to be printed onto paper. The first device 330 and the second device 350 may comprise a host device, a server, and the like.

The first device 330 is configured such that a request for printing of a specific image data stored in the recording medium 317 (hereinafter, referred to as a “requester”) can send a request for printing to the control unit 321. The first device 330 comprises a request unit 331.

The request unit 331 receives a request for printing from a requester, transfers the request to the control unit 321, and displays the response from the control unit 321, to the requester.

In response to a request for printing from a requester, the request unit 331 requests a list of image data stored in the recording medium 317 from the control unit 31, and displays the list to the requester so as to enable the selection of a desired image data. In addition, the request unit 331 receives as an input from the requester image data to be printed and the requester identification. The request unit 331 transfers the request for printing, comprising information on the selected image data and the requester identification, to the control unit 321.

The second device 350 is configured such that an approval authority can approve a request for printing from the first device 330, which is transferred through the control unit 321. The second device 350 comprises an approval unit 351. The approval authority denotes an entity, comprising the creator of an image data, who has an authority to approve the relevant image data.

The approval unit 351 receives a request for printing from the first device 330, and receives as an input from the approval authority a printing approval therefor, which is transferred to the control unit 321.

In order to approve the requested printing, the approval unit 351 receives as an input from the approval authority an authorization code and transfers the authorization code to the control unit 321. In addition, the approval unit 351 displays to the approval authority the information, comprising error messages, which may be transferred from the control unit 321.

In one embodiment, the first device 330 and the second device 350 may be provided in a single device.

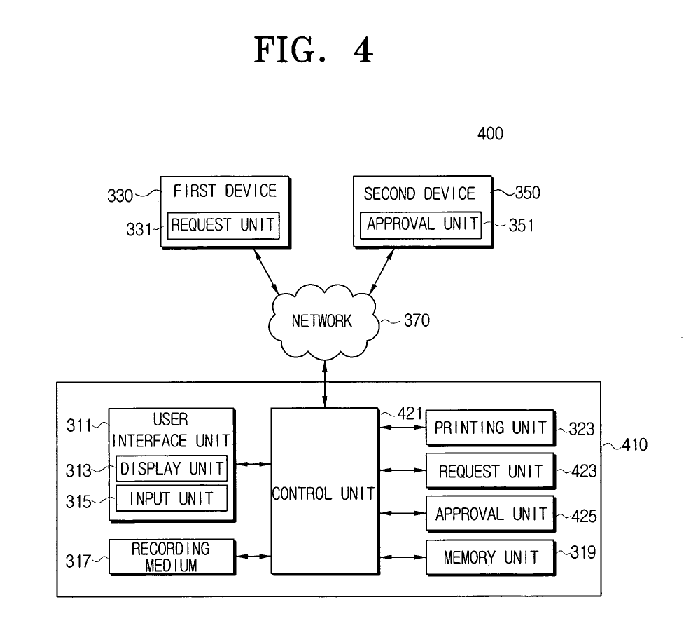

FIG. 4 is a block diagram showing an image forming system having a security authentication function for image data according to another embodiment of the invention. Referring to FIG. 4, a request unit 423 and an approval unit 425 are further provided in the image forming apparatus 310. The same elements as in FIG. 3 are denoted by the same reference numerals and details thereon will not be repeated here.

In contrast to FIG. 3, the control unit 421 receives a request for printing from the request unit 423, not from the first device 330, and obtains a printing approval from the approval unit 425, not from the second device 350.

The request unit 423 and the approval unit 425 are operated in the same manner as the request unit 331 of the first device 330 and the approval unit 351 of the second device 350 in FIG. 3.

A requester can request a printing of a desired image data directly to the image forming apparatus 410, not to the first device 330. Further, the approval authority can approve the printing in the image forming apparatus 410, when required, not in the second device 350.

In another embodiment of the invention, the request unit 331 or the first device 330 may be provided in the image forming apparatus 410. In this case, a requester can request a printing of a desired image data directly in the image forming apparatus 410, not in the first device 330.

In yet another embodiment of the invention, the approval unit 351 or the second device 350 may be provided in the image forming device 410. In this case, the approval authority itself can select an approvable image data, request a printing therefor, and input an authorization code, directly in the image forming apparatus 410.

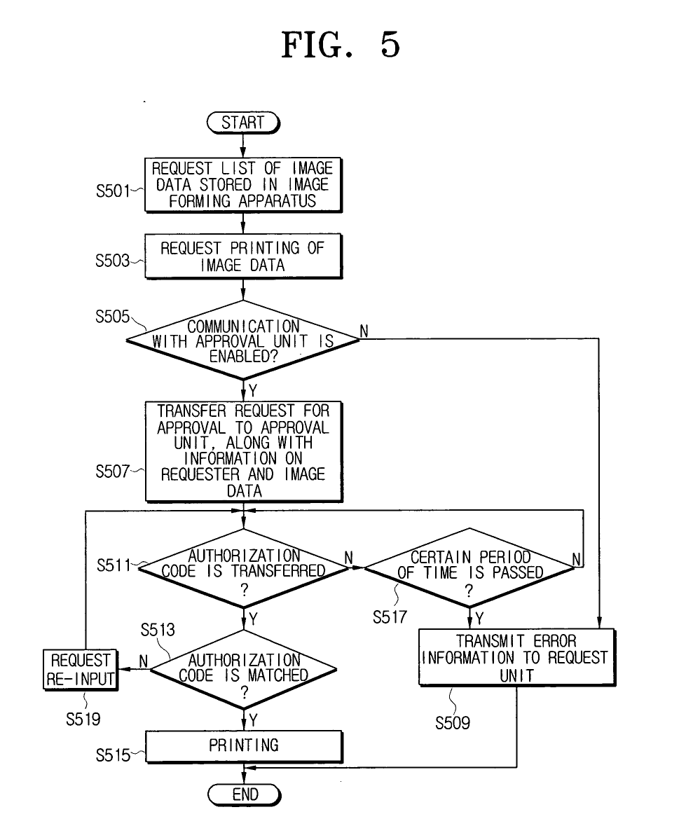

FIG. 5 is a flow chart illustrating the operation of the image forming system having the security authentication function according to an embodiment of the invention. Hereafter, the security authentication function will be described in detail, with reference to FIGS. 3 and 4.

If a request for printing an image data (which is stored in the recording medium of the image forming apparatus 310) is received from a requester, the request unit 331 requests from the image forming apparatus 310 a list of image data stored in the recording medium 317. In response, the control unit 321 of the image forming apparatus 310 reads out a list of the concerned image data from the memory unit 319 and transfers the list to the request unit 331 at step S501.

If the requester inputs the requester identification through the list of image data provided by the request unit 331 and requests a printing, the request unit 331 transfers information on the requested image data and the requester identification to the control unit 321 at step S503.

If a request of printing is received, first the control unit 321 confirms whether communication with the approval unit 351 of the second device 350 is enabled at step S505. If the communication is enabled, the control unit 321 reads out the requester information corresponding to the requester identification from the memory unit 319, which is transferred to the approval unit 351 of the second device 350, along with information on the requested image data at step S507.

As a result of the determination at step S505, if the communication with the second device 350 is not enabled, the control unit 321 transfers unavailability of communication to the request unit 331 at step S509.

If the request of printing is received from the control unit 321, the approval unit 351 displays to the approval authority the information on the relevant request and the requested image data and receives as an input an authorization code for a printing approval. The approval unit 351 transmits the authorization code to the control unit 321 of the image forming apparatus 310 at step S511.

When the authorization code is transferred, the control unit 321 determines whether the transferred authorization code is matched with the authorization code attached to the requested image data, which is stored in the memory unit 319 at step S513. If the authorization code is matched, the control unit 321 transforms the request image data and transmits to the printing unit 323, which prints the corresponding image on a print paper at step S515.

If the authorization code is not transferred within a certain period of time, the control unit 321 transfers the relevant error information to the requester through the request unit 331 of the first device 330 at steps S517 and S509. Further, as a result of the determination at step S513, if the authorization codes are not matched, the control unit 321 requests the approval authority to re-input the authorization code, through the approval unit 351 of the second device 350 at step S519.

The image forming system having a security authentication function for image data is operated in the above-described manner.

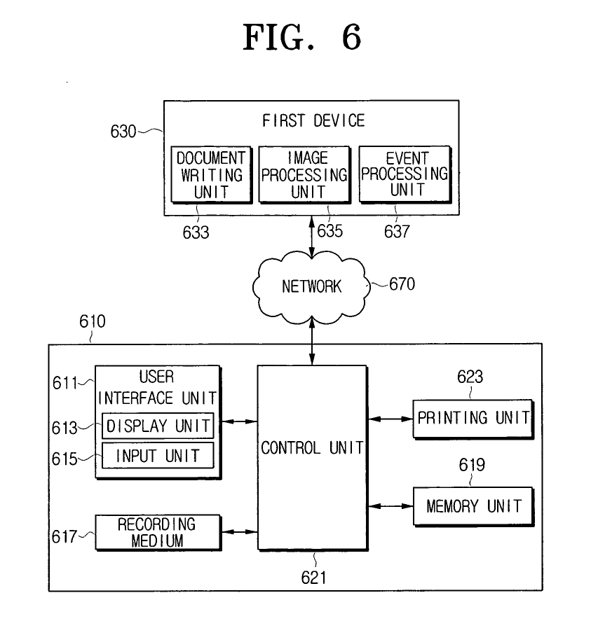

FIG. 6 is a block diagram of an image forming apparatus having a management function for stored image data according to an embodiment of the invention.

Referring to FIG. 6, the image forming apparatus 610 of the invention is connected, through a network 670, to a plurality of client devices (not shown) comprising a first device 630. In FIG. 6, however, only a singe device, i.e., the first device 630 is illustrated, for convenience.

The network 670 comprises a wired and wireless network, through which a single image forming apparatus 610 can be shared by a plurality of client devices.

The first device 630 can be connected to the network 670, and generate an image data such as a document, a photograph, or the like to be printed through the image forming apparatus 610. The first devices 630 comprises a computer, a digital camera, a scanner, a notebook, a cellular phone, a personal digital assistant (PDA), and the like.

The first device 630 comprises a document writing unit 633, an image processing unit 635, and an event processing unit 637. If the document writing unit 633 generates a document to be printed and a printing command is received from a user, the first device 630 transfers the document to be printed to the image processing unit 635.

The image processing unit 635 transforms the transferred document into a format processible in the image forming apparatus 610, and sends the transformed document to the image forming apparatus 610, which prints the document.

Preferably, the image data generated by the first device is transferred to the image forming apparatus 610 in the unit of a job, which comprises at least one page. In addition, the first device can transmit the generated image data in various modes. The following three modes are preferred.

The first mode is a storage mode, in which the image forming apparatus 610 receives an image and stores it in a storage means for a pre-established period of time. The stored image data may be deleted or re-stored after being printed. Hereinafter, an image data of a single job, which is transmitted to the image forming apparatus 610 in a storage mode, will be referred to as a “storage mode job.”

The second mode is a safe mode, in which a received image data is not immediately printed, but printed after a password is input from a user and then the safe mode is released. Hereinafter, an image data of a single job, which is transmitted to the image forming apparatus 610 in a safe mode, will be referred to as a “safe mode job.”

The third mode is a delay mode, in which a received image data is printed at a certain pre-determined time. Hereinafter, an image data of a single job, which is transmitted to the image forming apparatus 610 in a delay mode, will be referred to as a “delay mode job.”

The event processing unit 637 receives and processes a state change information, which is displayed in a user-recognizable form. If the image forming apparatus 610 transmits a state change information directly to the first device 630, the event processing unit 637 processes the transferred state change information. In another embodiment of the invention, the event processing unit 637 may be included in the image processing unit 635.

The image forming apparatus 610 is provided with a storage means for storing an image data, which is transmitted in the unit of a job, and thus can store the image data transmitted in the above mode for a certain period of time for a certain desired purpose.

In addition, the image forming apparatus 610 notifies a user of a state change information on the event, which occurred in each of the stored mode jobs, such that the user can take an immediate measure or a post-measure.

The state change information corresponds to any one of the cases where a storage mode job is printed, not printed even after a pre-established time, and deleted. In case of a safe mode job, the state change information corresponds to the case where the safe mode job is deleted, printed, or the safe mode is not released even after a desired time. In case of a delay mode job, it corresponds to the case where the delay mode job is printed.

The image forming apparatus 610 can transfer the state change information to a designated receiver device (not illustrated), which is included in the first device 630. The image forming apparatus 610 already knows the network address of first device 630, or can confirm the user's first device 630 using a universal plug & play (UPNP).

Furthermore, in the case where the first device 630 is a portable wireless terminal comprising a cellular phone, it can transmit the state change information to the user, using a character message or a voice message.

In addition, the image forming apparatus 610 may notify a user of the state change information, using the user's email address. In case of using the user's email address, the device, in which the user can be notified of the state change information, is not limited to the first device 630, but may comprise a device (not shown) connected to the network 670 or other network, as long as it can receive an email.

For this purpose, a job, which is generated in the first device 630 and transmitted to the image forming apparatus 610, is preferred to comprise a user's email address.

Hereafter, each element of the image forming apparatus 610 will be explained with reference to FIG. 6.

The image forming apparatus 610 may comprise a computer printer, a replicator, a photoprinter, and the like, capable of being connected on the network 670. The image forming apparatus 610 performs a printing job in response to a printing command from a client device comprising the first device 630 onto the network 670.

The image forming apparatus 610 comprises a user interface unit 611, a recording medium 617, a memory unit 619, a control unit 621, and a printing unit 623.

The user interface unit 611 comprises a display unit 613 and an input unit 615.

The display unit 613 denotes a device, in which information transmitted from the control unit 621 is displayed in the form of a character or figure so as to be recognizable to the user. The display unit 613 can employ a LCD or other display devices capable of displaying a character or figure.

The display unit 613 displays various kinds of information for a user's printing command, under control of the control unit 621. In addition, in case of a printing command for an image data stored in a safe mode, the display unit 613 displays such that a password can be input, according to the control of the control unit 621.

The input unit 615 is configured to be able to input a user's printing command for a storage mode job, a safe mode job and a delay mode job, and a command for establishment and change of various settings of the image forming apparatus 610, and also a password for a safe mode job, and the like.

The recording medium 617 is a device where the image data transmitted through the first device 630 is spooled and stored in the unit of a single job. The recording medium 617 may employ a memory element, a hard disk, a floppy disk, and the like. In addition, an external recording medium using a flash memory element may be employed. Preferably, a hard disk can be used as the recording medium 617.

The memory unit 619 denotes an active or inactive memory device, in which an operating program for the image forming apparatus 610 is stored, and an image data stored in the recording medium 617 or received from the first device 630 is temporarily stored while being processed for a final printing.

The printing unit 623 receives an image data to be printed from the control unit 621 and prints an image corresponding to the received image data on a print paper.

The control unit 621 controls the entire image forming processing of the image forming apparatus 610, and also processes a user's command input through the input unit 615. In case of printing jobs received in each mode, the control unit 621 controls such that the image data is transformed into a format processible in the printing unit 623 and the transformed image data is transferred to the printing unit 623 for printing.

The control unit 621 administrates an image data stored in the recording medium, according to each individual mode therefor. In addition, when various state change information occurs, the control unit 621 sends it directly to the first device 630, or notifies the user of it using email.

The control unit 621 receives a storage mode job, a safe mode job and a delay mode job from the first device via the network 670 and stores them in the recording medium 617.

In case of a storage mode job, the control unit 621 stores the storage mode job in the recording medium for a pre-established desired period of time. In addition, when the storage mode job is printed, the control unit 621 generates a ‘first printing state change information’ comprising a content about the printing and transfers it to the user. If the storage mode job is deleted, the control unit 621 generates a ‘first deleting state change information’ comprising a content about the deleting and transfers it to the user. In addition, when an established time is reached for a storage mode job, the control unit 621 generates a ‘first time arrival state change information’ comprising a state change information on the arrival of established-time and transfers it to the user.

In case of a safe mode job, if the safe mode job is not printed until the established time is reached, the control unit 621 generates a ‘second time arrival state change information’ therefor and transfers it to the user. If the safe mode job is printed by inputting a password, the control unit 621 generates a ‘second printing state change information’ comprising a state change information on the printing and transfers it to the users.

In case of a delay mode job, the control unit 161 allows the delay mode job to be printed when a desired time is reached, and when printed, generates a ‘third printing state change information’ comprising a state change information on the printing of delay mode job and transfers it to the user.

When an event occurs on a storage mode job, a safe mode job and a delay mode job, the control unit 621 may transfer to the user a state change information on the event, using the user's email address attached to each job. Alternatively, in case of no email address attached to the job, or by a user's preset command, the state change information is transferred directly to the user's device, i.e., the first device 630, and the event processing unit 637 of the first device 630 displays it to the user.

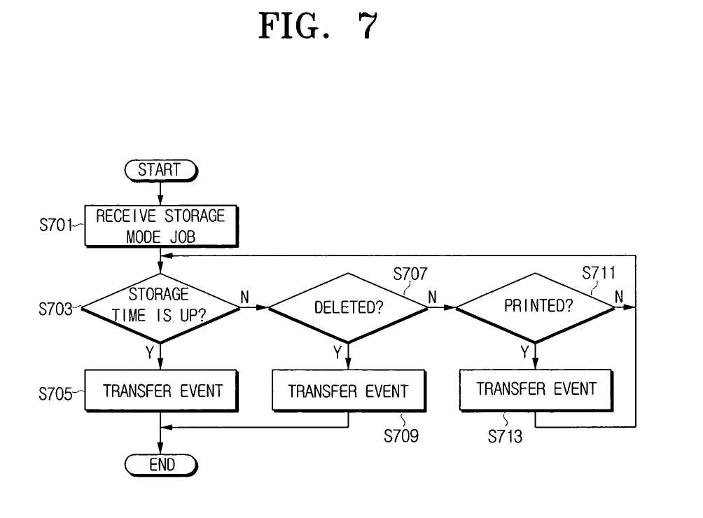

FIG. 7 is a flow chart illustrating a method of processing a storage mode job in the image forming system of the invention.

If a storage mode job is received from the image processing unit 635 of the first device 630, the control unit 621 of the image forming apparatus 610 stores the received storage mode job in the recording medium 617 at step S701.

The control unit 621 stores the storage mode job in the recording medium for a desired period of time, which is pre-set in the storage mode job. Then, when a preset time is reached with respect to the storage mode job stored in the recording medium 617 at step S703, a first time arrival state change information comprising information on the time arrival is transferred.

In one embodiment of the invention, either a delete command or a store command may be received again from the user, in response to the first time arrival state change information. Due to this command, the storage mode job can be deleted, or a desired time is re-established to the storage mode job, which thereby is stored at step S705.

At step S703, the control unit 621 determines whether the storage mode job is deleted before reaching the established time at step S707.

At step S707, if the storage mode job is determined as having been deleted, the control unit 621 transmits a first deleting state change information to the user at step S709.

In addition, as a result of the determination at step S707, if the storage mode job is not deleted, the control unit 621 determines if it is printed at step S711. If printed, the control unit 621 transfers a first printing state change information to the user at step S713. If not printed, the process returns to step S703 and makes a confirmation as to whether the storage time established to the storage mode job is reached.

The management function for a storage mode job is performed in the above-described manner.

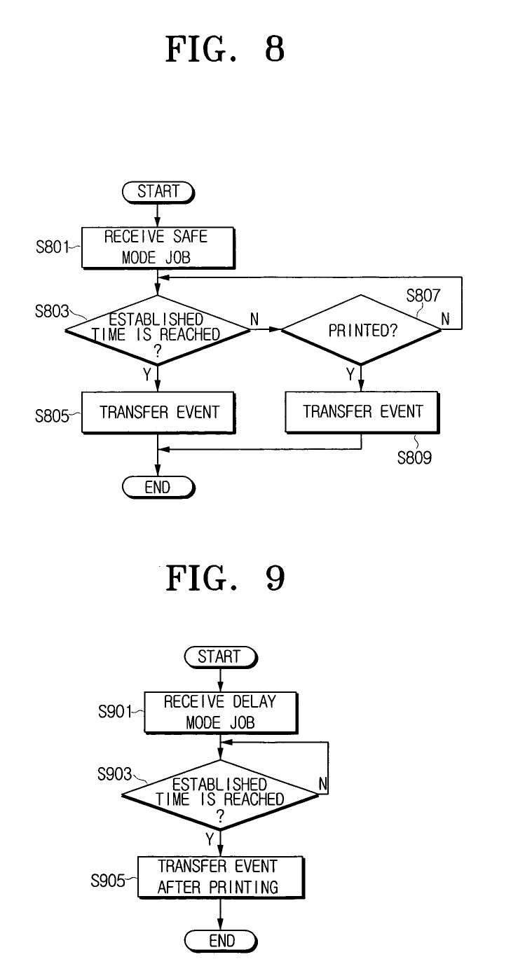

FIG. 8 is a flow chart illustrating a method of processing a safe mode job in the image forming system of the invention.

If a safe mode job is received from the image processing unit 635 of the first device 630, the control unit 621 of the image forming apparatus 610 stores the received safe mode job in the recording medium 617 at step S801.

The control unit 621 stores the safe mode job in the recording medium for a desired period of time, which is established to the safe mode job. Then, when the established time is arrived with respect to the safe mode job stored in the recording medium 617 at step S803, the control unit transfers a second time arrival state change information comprising information on the time arrival.

In another embodiment of the invention, either a delete command or a store command may be received again from the user, in response to the second time arrival state change information. Thus, the safe mode job can be deleted, or a desired time is re-established to the safe mode job, which thereby is re-stored. Alternatively, the concerned safe mode job may be deleted, without necessity of waiting for a response from the user at step S805.

At the step S803, the control unit 621 determines whether a password is input and the safe mode job is printed before the established time is not reached at step S807.

At step S807, if the safe mode job is determined as having been printed, the control unit 621 transmits a second printing state change information to the user. Similar to step 805, the control unit 621 may receive from the user a command for post-treatment of the safe mode job at step S809.

If the safe mode job is not printed, the control unit 621 returns to step S803 and makes a confirmation as to whether the established time for the safe mode job is reached.

In another embodiment of the invention, in case where the concerned safe mode job is deleted by means of a password, a state change information comprising information on the deleting may be transmitted to the user, correspondingly to the steps S707 and S709 in FIG. 7.

The management function for a safe mode job according to an embodiment of the invention is carried out in the above-described manner.

FIG. 9 is a flow chart illustrating a method of processing a delay mode job in the image forming system of the invention.

If a delay mode job is received from the image processing unit 635 of the first device 630, the control unit 621 of the image forming apparatus 610 stores the received delay mode job in the recording medium 617 at step S901.

The control unit 621 stores the delay mode job in the recording medium for a desired period of time, which is established to the delay mode job. In addition, if the established time is reached with respect to the delay mode job stored in the recording medium 617 at step S903, the concerned delay mode job is printed and a third printing state change information comprising information on the printing of the delay mode job is transferred at step S905.

If the established time for the delay mode job is not reached, the control unit 621 waits until the established time.

The management function of a delay mode job is performed in this manner.

As described above, according to embodiments of the present invention, when a device user on a network prints a document held in its own device for other users, the device user can print the document after obtaining the relevant user's approval. Thus, unnecessary printing of documents can be avoided and also the document can be efficiently transferred. In addition, the security problem relating to the documents can be solved.

In addition, the image data stored in the recording medium of the image forming apparatus can not be printed, without approval from the approval authority. The sharing work is performed through a network and thus the user's efforts and time required for the sharing work can be saved. Furthermore, the recording medium of the image forming apparatus is shared using a network and thus the entire resources of system can be efficiently utilized.

A management can be performed, depending on the storage mode of a job stored in the image forming apparatus. Thus, if the job to be stored increases, it can be appropriately managed, thereby avoiding a case where a required job cannot be finished due to the jobs stored in the recording medium, or preventing a decrease in the efficiency of the image forming apparatus.

Furthermore, owing to this management function, a required job can be prevented from being arbitrarily deleted. A state change information occurring in each storage mode is indicated to the user and thus the user can take appropriate measures.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An image forming system comprising a first device and a second device connected to a network, and having an output permission and result notification function for image data stored in the first device, the system comprising:
a control unit for transferring a request for approval of the first device to the second device, the request of approval comprising requesting an approval of the second device for printing of the image data, transferring to the first device a response of the second device to the request for approval, and transforming the image data into a printable format and outputting the transformed image data, the image data being transferred to the control unit from the first device in response to an output permission in the response of the second device; and
a printing unit for printing on a print paper an image corresponding to the transformed image data output from the control unit.

2. The image forming system as claimed in claim 1, wherein, if the printing unit prints an image corresponding to the image data on a print paper, the control unit transfers the output result to the second device.

3. A method of performing an output permission and result notification in an image forming system having a first device, a second device, and an image forming apparatus, which are connected onto a network, the method comprising steps of:
transferring a request for approval to the image forming apparatus by means of the first device, the request of approval comprising requesting an approval of the second device for printing of an image data stored in the first device;
transferring the request for approval to the second device by means of the image forming apparatus;
making a response to the request for approval by means of the second device, the response comprising an output permission;
transferring the response to the first device by means of the image forming apparatus;
transferring the image data to the image forming apparatus by means of the first device, in response to the output permission in the response;
printing an image corresponding to the image data by means of the image forming apparatus; and
transferring the printing result to the second device by means of the image forming apparatus.

4. A method of performing a security authentication in an image forming system having a first device, a second device, and an image forming apparatus, which are connected onto a network, the method comprising the steps of:
requesting a printing of an image data stored in the image forming apparatus by means of the first device;
requesting an approval for printing to the second device by means of the image forming apparatus;
approving the request for printing, in response to the request for approval of printing by means of the second device; and
printing an image corresponding to the image data on a print paper by means of the image forming apparatus, in response to the approval.

5. The method as claimed in claim 4, wherein the step of requesting the printing comprises the steps of:
requesting a list of image data stored in the image forming apparatus by means of the first device;
transferring the list to the first device by means of the image forming apparatus; and
selecting the image data from the list and requesting the image forming apparatus print the selected image data.

6. The method as claimed in claim 5, wherein the step of requesting the printing comprises a step of:
the first device receiving as an input an identification of a requester, who requests a printing, and transferring of the identification to the image forming apparatus, along with the image data.

7. The method as claimed in claim 5, wherein the step of requesting the approval comprises a step of:
transferring to the first device information, corresponding to a case where the second device cannot perform communication on the network.

8. An image forming system having a security authentication function for an image data stored in an image forming apparatus and having one or more device connected to a network, the image forming system comprising:
a first device for performing a printing request of a requester with respect to the image data;
a second device for performing a printing approval of an approval authority with respect to the image data;
a recording medium for recording the image data; and
a control unit for receiving the printing request for the image data from the first device and transferring the printing request to the second device, and receiving the printing approval from the second device and transforming the image data in order to print an image corresponding thereto on a print paper.

9. The system as claimed in claim 8, further comprising a printing unit printing an image corresponding to the transformed image data, which is received from the control unit.

10. The system as claimed in claim 8, wherein the first device requests from the control unit a list of image data stored in the recording medium, and the control unit transfers the list to the first device in response to the request for the list from the request unit.

11. The system as claimed in claim 8, wherein, with respect to the printing request, the first device receives as an input an identification of the requester and transfers the identification to the control unit.

12. The system as claimed in claim 8, wherein, with respect to transferring of the printing request, the control unit transfers to the first device information, which corresponds to a case where the second device cannot perform communication on a network.

13. The system as claimed in claim 8, wherein the second device receives as an input an authorization code from the approval authority and transfers the authorization code to the image forming apparatus.

14. A method of managing a stored image data in an image forming apparatus, the method comprising the steps of:
receiving a printing job stored in any one option among a plurality of storage options;
storing the received printing job; and
transmitting a state change information occurring in the stored printing job to a user through a network.

15. The method as claimed in claim 14, wherein the step of transmitting comprises a step of:
transmitting the state change information using any one of a user's email address, a character message and a voice message.

16. The method as claimed in claim 14, wherein, when the storage options correspond to a storage mode which stores the printing job for a pre-established period of time, the state change information comprises information on any one of cases where the printing job is printed, the printing job is deleted, and the established time is reached.

17. The method as claimed in claim 14, wherein, when the storage options correspond to a safe mode which requires an input of a password for the execution of the printing job, the state change information comprises information on any one of cases where the printing job is printed and the established time is reached.

18. The method as claimed in claim 14, wherein the state change information comprises information on a state where the printing job reaches a pre-established time and is thus printed, the information corresponding to a delay mode where the printing job is printed after a pre-established period of time.

19. An image forming apparatus having a management function for a stored image data and connected to a first device through a network, the image forming apparatus comprising;
a recording medium for storing a printing job established in any one option among a plurality of storage options;
a control unit for storing into the recording medium the printing job received from the first device and transmitting to a user a state change information occurring in the stored printing job; and
a printing unit for printing an image corresponding to an image data transferred from the control unit on a print paper.

20. The apparatus as claimed in claim 19, wherein the control unit transmits the state change information using any one of a user's email address, a character message and a voice message.

21. The apparatus as claimed in claim 19, wherein, when the storage options correspond to a storage mode which stores the printing job for a pre-established period of time, the state change information comprises information on any one of cases where the printing job is printed, the printing job is deleted, and the established time is reached.

22. The apparatus as claimed in claim 19, wherein, if the storage mode printing job reaches a pre-established time and the state change information is transferred to a user, any one command of deleting the storage mode printing job and storing the storage mode printing job by means of a new establishment of time is received from the user.

23. The apparatus as claimed in claim 19, wherein, when the storage options correspond to a safe mode which requires an input of a password for the execution of the printing job, the state change information comprises information on any one of cases where the printing job is printed and the established time is reached.

24. The apparatus as claimed in claim 19, wherein the state change information comprises information on a state where the printing job reaches a pre-established time and is thus printed, the information corresponding to a delay mode where the printing job is printed after a pre-established period of time.
